(19) United States
(12) Patent Application Publication
(10) Pub. No.: US 2011/0099270 A1
(43) Pub. Date: Apr. 28, 2011

(54) Communications Device and Method of Operation Thereof

(75) Inventors: Peter Hartman, London (GB); Jonathan Young, Southfields (GB)

(73) Assignee: NOKIA CORPORATION, Espoo (FI)

(21) Appl. No.: 12/740,916

(22) PCT Filed: Sep. 10, 2008
(86) PCT No.: PCT/GB2008/003074

§ 371 Date: Dec. 16, 2010

(30) Foreign Application Priority Data
Oct. 31, 2007 (GB) 0721414.1

(51) Int. Cl. G06F 15/173

(52) U.S. Cl. 709/224

(57) ABSTRACT

A communications device, such as a mobile telephone, fixed line telephone, computer with network access, or any other similar device which is equipped to communicate using network and/or telephony protocols, is provided, wherein before a call or other communications sessions is set up and made, a determination of the present time at the intended recipient of the call or session is made. In some embodiments, this determination of the time at the intended recipient's location is displayed to a user of the calling device to allow the user to decide whether to proceed with a call to the intended recipient. In other embodiments the determined time is compared with a set of one or more predetermined time bands during which calls to a recipient should not be made. Depending on the results of the comparison, the operation of the communications device is altered, for example, in one embodiment the call is not made, and the user preferably informed. In another embodiment, the user (caller) is advised that the call is being made at an inappropriate time for the intended recipient, and prompted to indicate whether the call should proceed. With such techniques, the problems noted above of unwanted calls being set up unnecessarily can be addressed.

### TECHNICAL FIELD

The present invention relates to a communications device and associated method of operation of such a device, wherein the communications device calculates the present time at an intended call recipient's location, and the operation of the device is modified in response to the calculated time.

### BACKGROUND TO THE INVENTION AND PRIOR ART

Most people would agree that it is bad manners to gratuitously telephone another person in the middle of the night, or even to call after a certain hour in the late evening. When it is essential to make such a call, even if it is believed that the call might not actually be waking someone up but there is the possibility of doing so, it is very common to begin the conversation by apologizing for telephoning at such a possibly anti-social hour.

The applicant's previous International patent application no. WO 2006/067449 recognised this same problem, and particularly in the context of mobile telephones, which can “roam” from network to network around the world, and hence the time at the location of the telephone can never be known for certain by a potential caller. To get around the problem of receiving unwanted calls at inappropriate times such as the middle of the night, WO 2006/067449 proposes a method of managing incoming calls on such “roaming” mobile phones.

In particular, in the system of WO 2006/067449 records are maintained of both the normal home network and time zone of the user of the mobile device and also the network and time zone in which the device is operating. A comparison of these records, optionally in conjunction with other relevant information such as caller identity information (CID) or the user's contacts or address book information, is used for incoming call management. For example, a call received at an antisocial time in the user's current location is not passed to the user, with a recorded message being played to the caller, preferably in the language of the caller, specifying the time zone in which the user is currently located, along with the local time. The caller may then abort the call without disturbing the recipient, divert to voicemail, or continue with the call if it still considered sufficiently urgent with the information then known to the caller. The call management system may self cancel when the user returns to the home network and time zone.

Whilst the techniques of WO2006/067449 substantially solve the above noted problem of receiving calls at inappropriate hours, they do so by providing for modification of the mobile telephone such that the telephone can potentially reject the call once the call has been received. However, the call is still made in the first place, and hence network resources in setting up the call and routing the call are wasted, since the call is in any event unwanted. Such network resources may be usefully employed in servicing wanted calls, and particularly at times of high network load. Moreover, even though the call is unwanted, on some billing tariffs a mobile telephone user can be billed a small amount simply for routing the call to a mobile telephone, and likewise, the caller may also be billed a small amount. At both the caller's and callee's sides unnecessary expense may therefore be incurred.

Additionally, the techniques of WO2006/067449 are particularly adapted for mobile telephone use, in that they require the modification of a mobile telephone and are applicable only really in that context. However, fixed line telephones still account for a large proportion of voice calls, and Voice-over-IP technology (VoIP) is also taking an increasing amount of voice traffic. To provide solutions which can be applied across all these communications domains then it is necessary to provide a solution which addresses the main problem which WO 2006/067449 acknowledges but then avoids. In particular, to allow for a more generic solution which can be applied across fixed-line, mobile, and VoIP domains, it would be more appropriate to provide a technique which prevents the unwanted call being made in the first place. Such a technique would then further address the technical and economic problems noted above of wasted network resources, and hence wasted cost.

### SUMMARY OF THE INVENTION

The present invention addresses the above noted problems by providing a communications device, such as a mobile telephone, fixed line telephone, computer with network access, or any other similar device which is equipped to communicate using network and/or telephony protocols, wherein before a call or other communications sessions is set up and made, a determination of the present time at the intended recipient of the call or session is made. In some embodiments, this determination of the time at the intended recipients location is displayed to a user of the calling device to allow the user to decide whether to proceed with a call to the intended recipient. In other embodiments the determined time is compared with a set of one or more predetermined time bands during which calls to a recipient should not be made. Depending on the results of the comparison, the operation of the communications device is altered, for example, in one embodiment the call is not made, and the user preferably informed. In another embodiment, the user (caller) is advised that the call is being made at an inappropriate time for the intended recipient, and prompted to indicate whether the call should proceed. With such techniques, the problems noted above of unwanted calls being set up unnecessarily can be addressed.

In view of the above, from a first aspect the present invention provides a method of operating a communications device comprising, prior to initiating a communications session with an intended recipient, determining an estimate of local time at the perceived location of the intended recipient; and controlling the communications device to perform an operation in dependence on the determined estimate.

Within the method of the first aspect the advantages are obtained that it is possible to take into account the estimate of local time at the intended recipient's location before the communications session is set up, and hence network resources are not wasted in setting up unwanted calls. Moreover, the original problem of preventing unnecessary calls at unwanted hours is also avoided.

Additionally, from a second aspect the invention provides a communications device comprising a communications session control unit which, prior to initiating a communications session with an intended recipient, determines an estimate of local time at the perceived location of the intended recipient; and controls the communications device to perform an operation in dependence on the determined estimate.

Further features and advantages of the present invention will be apparent from the appended claims.

### BRIEF DESCRIPTION OF THE DRAWINGS

Further features and advantages of the present invention will become apparent from the following detailed description of embodiments thereof, presented by way of example only, and wherein like reference numerals refer to like parts, and wherein:—

FIG. 1 shows a mobile terminal 10 of the prior art, and a typical contacts list which may be stored thereon;

FIG. 2 shows a typical fixed line telephone handset 20 of the prior art, and again that a contacts list may be stored thereon;

FIG. 3 shows a typical computer of the prior art connected to the Internet for making voice-over-IP calls, and a typical contacts list which may be stored therein;

FIG. 4 is a diagram illustrating contacts data which may be stored in a first embodiment of the present invention;

FIG. 5 is a flow diagram illustrating a method of operation of a communications device according to a first embodiment of the present invention;

FIG. 6 is a table used in a second embodiment of the present invention;

FIG. 7 is a table of data used in a third embodiment of the present invention;

FIG. 8 is a flow diagram illustrating a method of operation of a communications device according to a second embodiment of the present invention;

FIG. 9 is a flow diagram illustrating a method of operation of a communications device according to the third embodiment of the present invention;

FIG. 10 is a table of data used in a fourth embodiment of the present invention;

FIG. 11 illustrates example results from a database look up operation performed in the fourth embodiment of the present invention;

FIG. 12 is a table of data used in the fourth embodiment of the present invention;

FIG. 13 is a flow diagram illustrating a method of operation of a communications device according to the fourth embodiment of the present invention;

FIG. 14 is diagram showing contacts data that may be stored in a fifth embodiment of the invention;

FIG. 15 is diagram showing contacts data that may be stored in a sixth embodiment of the invention;

FIG. 16 is a drawing of a mobile telephone of a seventh embodiment of the invention;

FIG. 17 is a flow diagram of a method of operation of the mobile telephone according to the seventh embodiment of the invention;

FIG. 18 is a drawing of a mobile telephone of an eighth embodiment of the invention; and

FIG. 19 is a flow diagram of a method of operation of the mobile telephone according to the eighth embodiment of the invention.

### OVERVIEW OF THE OPERATION OF EMBODIMENTS OF THE INVENTION

Before embarking on a detailed description of embodiments of the invention it will be useful to provide a brief overview of the principles of operation behind the embodiments of the invention.

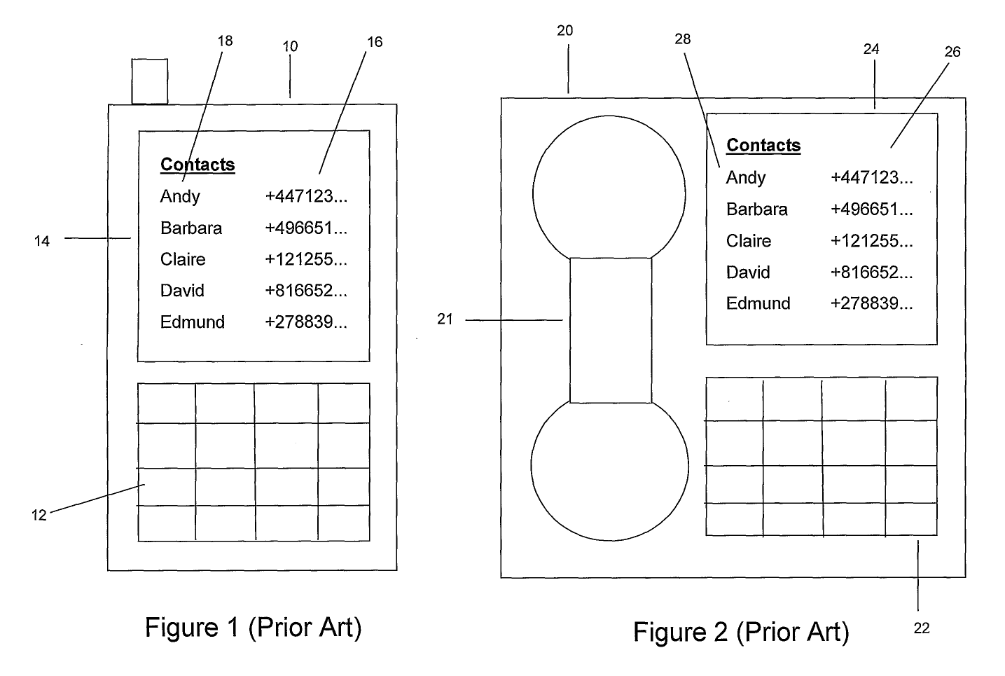

More particularly, FIGS. 1, 2, and 3 illustrate various communications devices of the prior art, but which may form the basis of embodiments of the invention. More particularly, FIG. 1 illustrates a typical mobile telecommunications device 10 of the prior art, which is typically provided with a keypad 12, and a display screen 14. The operation of such a mobile telecommunications device is conventional, and usually such a device would contain a contacts database containing contacts information of people the user of the mobile device may wish to call. To call one of the contacts, the keypad is used to operate the device to select one of the contacts from the list of contacts, and then a call command is made by the user, typically by pressing the appropriate button on the keypad 22. As shown, the contacts database will typically be indexed by name as shown by the names in name column 18, and will contain contact data such as one or more telephone numbers, email addresses, physical addresses, or the like, for each contact. Column 16 shows telephone numbers stored for each contact.

FIG. 2 shows a typical fixed line communications device 20, such as a fixed line telephone or the like. Again, such a fixed line communications device will typically have a keypad 22, and may have a display screen 24. In order to allow for conversations to be made and heard, a handset 21 is provided, having an earpiece, and a microphone. More modern fixed line telephones also allow for the storage of contact data, in the same way as a typical mobile device of the prior art. Such contact data would typically be arranged in a similar manner as in a mobile device, indexed by contact name as shown in column 28, and containing contact data such as the contact telephone number or numbers, as shown in column 26. To call one of the contacts, the keypad is used to operate the device to select one of the contacts from the list of contacts, and then a call command is made by the user, typically by pressing the appropriate button on the keypad 22. The call is then set up and made in the usual way, using the conventional PSTN.

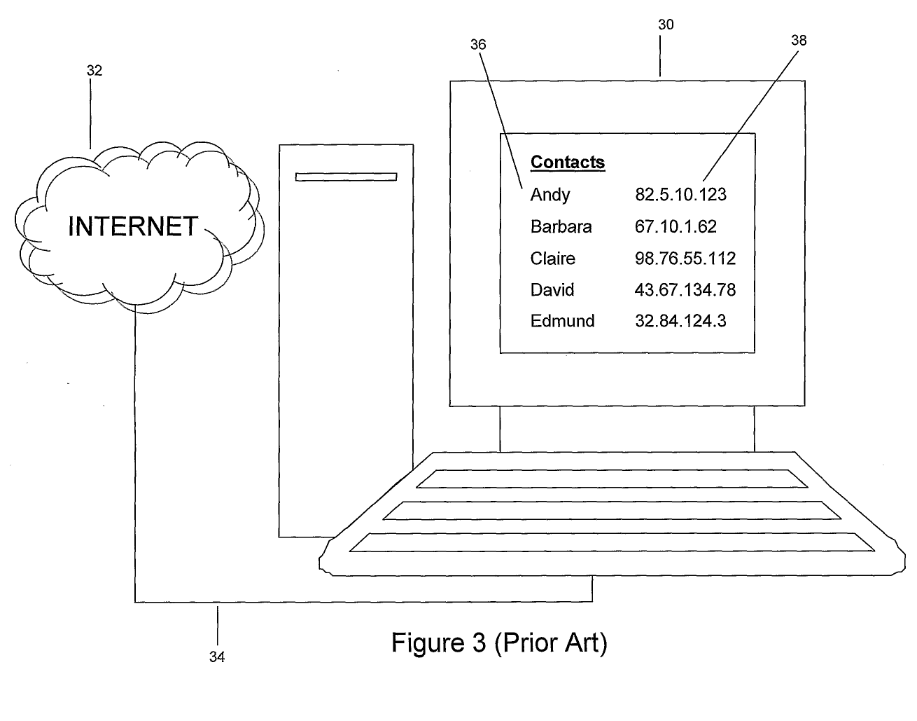

FIG. 3 illustrates a typical computer 30 of the prior art. The computer is provided with a network interface 34, to allow the computer to connect to and communicate over the Internet 32. The computer 30 is provided with software (not shown) to allow the computer to make voice calls using one of the various voice over IP (VoIP) protocols, such as H.323, or SIP. Whichever protocol is used, voice over IP requires the destination IP address to be inserted in the IP packet header carrying the voice data. IP addresses can be permanently assigned to individuals and/or organisations, or, more typically, a range of IP addresses will be assigned to an organisation or an ISP, that are then dynamically assigned to users. In such a case, an IP address is dynamically assigned to a user identified by his or her user name, when the user connects to the Internet. With typical “always on” DSL type connections where the Internet session is maintained continuously, then the same IP address is used for the whole session session.

It is therefore possible for a computer 30 to store IP address information such as shown in column 38 in its contact data. This would be in addition to other network identification information stored in the contacts, such as email addresses or the like. To initiate a voice over IP call, the computer 30 running the voice over IP software allows the user to select a contact to call, and, having selected a contact, then sets up the VoIP call in the usual manner. In some VoIP implementations, calls can be made to conventional telephones and in such a case a gateway router is provided in the network to interface between the IP network, and the PSTN to which the conventional telephone is connected.

Embodiments of the invention may be based on any of the above communications devices, or any other similar communications devices, which communicate via network or telecommunications protocols to allow communications sessions such as voice calls to be made. In other embodiments, the communications session may even be, for example, a video communication session, or the like.

To address the problem noted earlier of unwanted calls being set up at inappropriate times, within embodiments of the invention before setting up a call or communications session the communications device first determines an estimate of present time at the intended call recipient's location. This determination is preferably made based on addressing information available to the communications device preferably in the form of the telephone number, or the IP address, depending on the embodiment. Alternatively, the contacts data in the communications device can be supplemented with an extra field, which indicates either the time at the contact location, or, more preferably, a time difference between the contact's typical location, and the present location of the communications device making the call. Once the time has been estimated, in some embodiments the time estimate, or at least an indication thereof derived from the estimate is displayed to the user so that the user can make his own decision as to whether to continue with the call, without further assistance in the decision from the calling device. In other embodiment, however, the time estimate is compared with a set of one or more predetermined time bands, during which calls to the intended recipient should preferably not be made. If the estimated time then falls within one of the predetermined time bands, either the call is not set up, or, more preferably, the user is alerted to the inappropriate timing of the call, and is prompted as to whether they wish to continue with the call. In these other embodiments, therefore, the user is provided with further help from the calling device as to whether the call should be made, in the form of the call filtering performed by comparing the time estimate with the time bands within which calls should or should not be made.

Using such techniques then it becomes possible for a caller to be warned in advance that his or her call is being made at an inappropriate time for the intended recipient such as, for example, the middle of the night, or after work hours. The predetermined time bands may be global in that the same time bands are applied to every contact, or made individual to each contact i.e. each contact may have a set of one or more predetermined time bands during which calls to that contact should not be made.

### DESCRIPTION OF THE PREFERRED EMBODIMENTS

Having given a brief overview of the operation of the embodiments of the invention, there follows a detailed description of full specific embodiments of the invention.

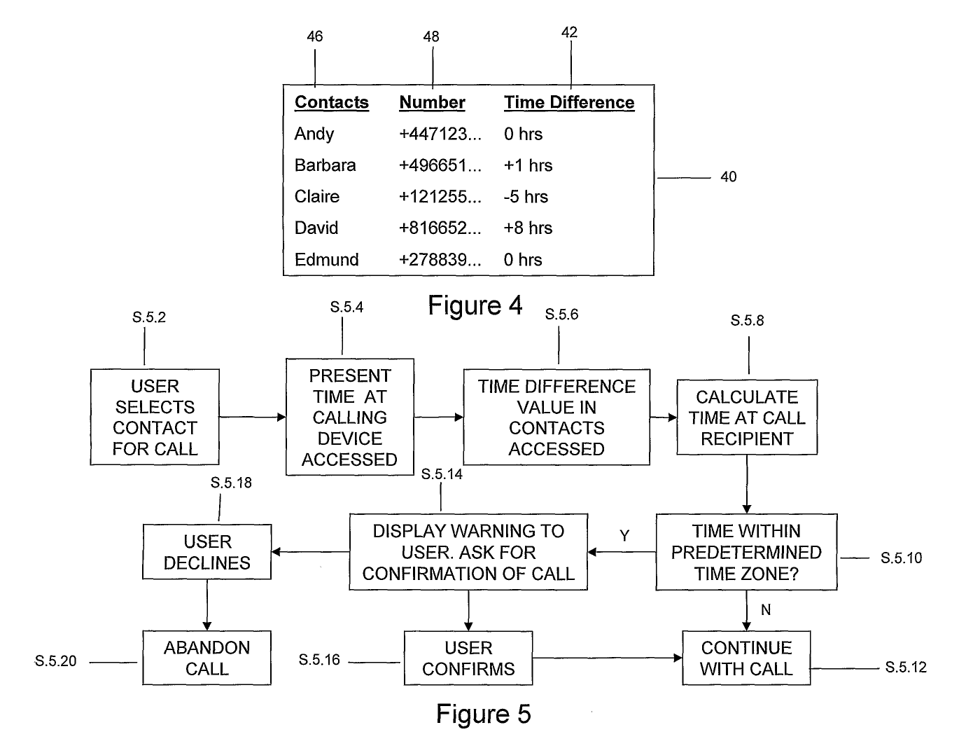

A first embodiment will now be described with respect to FIGS. 4 and 5.

The first embodiment of the present invention provides a communications device, such as the mobile communications device 10, or the fixed line communications device 20, wherein the contacts data stored within the device is supplemented to include an extra field for each contact, which indicates preferably the time difference between the device's present location, and the contact's usual location. FIG. 4 illustrates this supplemented contact data in the form of contact data table 40. Here, it can be seen that the contact data contains a column 46 of contact names, as well as a column 48 of contact address information, being in this case telephone numbers for the contacts. The full telephone numbers are given in this embodiment, including the international access code identifier “+”. Following the international access code identifier, as is known in the art the next one, two, or sometimes three numbers indicate the country to which the telephone number belongs. The area code, and then finally the particular number then follow.

The contact data 40 is characterised by having an additional field for each contact, being, in this case, the column 42 of time difference information. As will be seen in the example of FIG. 4, this contains time difference information measured in hours, indicating a difference in time from Greenwich Meantime (GMT) in dependence on the country location to which the contact number relates. Hence, as will be seen, the contact “Andy” has a number which starts “+44”, indicating that the contact is in the United Kingdom. In this case, the time difference between United Kingdom local time, and GMT, is given as 0 hours (in the summertime, it may of course be +1 hours, to account for daylight saving time). Similarly, the contact “Barbara” has a number starting “+49”, indicating that Barbara is located in Germany. Here, the typical time difference is +1 hour to GMT. In a similar vein, the contact Claire has a number that starts “+1”, indicating that she is in the United States. The area code “212” indicates that she is in New York city, and hence has a time difference of −5 hours compared to GMT. Likewise, David is located in Japan (country code “81”), and has a time difference of +8 hours, whereas Edmund, being located in South Africa (country code “27”) has no time difference compared with GMT. Note that the time in the present embodiment is stored in the time difference column 42 of the contact data 40, preferably having been calculated by the user, when the contact data is first entered.

In terms of providing the above time difference data in the table 40, for a fixed line telephone the time difference data will remain the same, once entered. However, for a mobile telephone which is capable of roaming, the time difference data may change. For example, a mobile phone user may use the same number in many different countries on opposite sides of the world, and hence with different time differences to the location of the calling device.

In order to get around this problem, within embodiments of the invention an additional signalling protocol is used in order to allow the signalling of time data relating to the local time et the location of a roaming mobile. This time data can then be received by a calling device, which then updates the time difference data 42 in the contact data 40.

More particularly, one technique which can be used to provide the signalling protocol is to use a messaging service such as the short message service (SMS) provided by mobile GSM systems. In this first technique, when a roaming mobile finds itself abroad, for example by detecting on power-up that it is unable to connect to its home network and can only “see” foreign networks, after connecting to one of the foreign networks and determining the time therefrom, the roaming mobile sends an SMS message in a predetermined format to contacts within its address book. The SMS message contains a tuple of data in a predetermined form, containing the address ID (i.e. telephone number) of the roaming mobile, and the determined time. The format of the SMS message may therefore be:—

<predefined header indicating time control message><message ID><telephone number><determined time>

At a receiving communications device the message is parsed and recognised as a time difference data control message. The telephone number of the sending mobile telephone is then read, and the local time data. The contacts data 40 is then updated, by calculating the time difference between present time at the communications device, and the received local time at the mobile, and the newly calculated time difference data is then used to update the time difference data 42 stored in the contacts data 40 against the received telephone number. In this way, the time difference data 42 for roaming mobiles can be continuously updated.

One of the problems with the above techniques is that it is dependent on the roaming mobile sending the SMS time control messages, and such a message being received at the calling communications device. Sending such SMS control message may incur much expense on the part of the roaming mobile. To get around this problem, therefore, another technique to find the time difference to be applied to a roaming mobile is for the roaming mobile to send its local time to a central server computer, which then sends out time difference control messages to update the time difference time in a calling device.

For example, a central server can be provided which allows a mobile phone user to register therewith. The mobile phone user also provides to the central server address IDs e.g. telephone numbers of communications devices which may try and call the mobile phone. Then, when the mobile phone finds itself in a foreign country it sends a time control message to the central server with its local time e.g. by SMS message, or by email, if a GPRS (or higher bandwidth) connection is available. On receipt of the time control message, the central server then propagates out the time control messages to the communications device which the mobile phone user registered with it. Each communications device would then receive a time control message, and be able to update its contact data 40 accordingly.

The central server may be run by a third party, or could be operated for example by the mobile network operator. When the mobile network operator detects that the mobile phone is out of the country, then it sends time control messages to each registered communications device which the mobile phone user has registered with it. This arrangement could be provided as part of a “Presence” service.

A third technique for detecting the time at a roaming mobile is to use location based services such as the Global positioning system to locate the mobile to be called. In this technique, the roaming mobile is equipped with a GPS receiver, which is in operation to determine the position of the roaming mobile, either continuously, or on request. The calling device, prior to initiating a call to the roaming mobile, but after the roaming mobile has been selected from the contacts list, then sends a query message to the roaming mobile, to ask the roaming mobile to perform a position fix using its GPS receiver, and to report back the determined location. The query message could be sent using Internet Protocol, or another messaging protocol, such as SMS. The roaming mobile then responds with the determined location in a response message.

At the calling device the response message is received, and the location information can be used as an index into a look-up table which relates geographical location to time, or time difference. With this information, it then becomes possible for the calling device to display the time at the roaming mobile location in the contacts list, or to display or store a time difference for the roaming mobile. This time or time difference data can then be used by the user or the calling device to determine whether a call should be initiated, using the embodiments to be described.

Returning to the first embodiment, being provided with such information in the contact data, the communications device which makes use of such contact data, such as the mobile telephone 10, or the fixed line telephone 20, is able to estimate the time at the intended called number location, and compare predetermined time bands within which calls to a particular number should not be made. Therefore, as well as the time difference information in the contact data, the communications device 10 or 20 using the first embodiment of the invention also stores at least one or more sets of time band information, indicating ranges of time during which calls to particular numbers should not be made. As mentioned previously, the communications device may store a set of time bands individually for each contact, or may store a set of time bands which are applied globally to all contacts. Additionally, a mix of both techniques could be used, where some contacts have specific sets of time bands stored, whereas the global sets of time bands are used for the remaining contacts. Furthermore, preferably it is possible to mark a contact as being contactable at all times. Preferably the time bands, whether global, or specific to a particular user, are user definable.

FIG. 5 illustrates the method of operation of a communications device such as the mobile telephone 10, or fixed line telephone 20, operating in accordance with the first embodiment. Firstly, at step 5.2 a user selects a contact from the contacts list maintained on the device to whom he wishes to make a call. This selection is performed in a conventional manner, as known in the art. Having made this selection, next the device at step 5.4 accesses its own internal clock, to determine the present time at its present location. In this respect, for fixed line telephones, and in particular those models which contain a contacts list, an indication of time is also usually stored, so that the display can display a clock. For mobile telephones, again a clock is usually included in such devices. Additionally, it is also possible for mobile telephones to obtain the local time from the mobile network to which they are connected.

After accessing the local time at the calling device, at step 5.6 the contacts data 40 is accessed, and the time difference value 42 for the particular selected contact is obtained. This then allows, at step 5.8, the local time at the call recipient's location to be calculated, by adding or subtracting the time difference to or from the present time in GMT. In this respect, if the local time is not GMT then a GMT representation can first be found. Alternatively, in another embodiment, where the local time is not GMT, the time difference data 42 in the contacts data 40 may represent the time difference of the contact location, with respect to the local time. In such a case, no local time conversion to GMT is then required.

Having calculated the local time at the call recipient location, at step 5.10 an evaluation is performed to compare the calculated time from step 5.8 with the predetermined time bands stored in the communications device. As mentioned previously global time bands may be stored which are applied to some or all contacts, or individual time bands may be stored for each contact. If individual time bands are stored for the selected contact, then these are used, otherwise the global time bands are used.

The time band data takes the full ranges of times during which calls should not be made. For example, one set of time bands may be:—

{2300 to 0000, 0000 to 0600, 1200 to 1400}

With such time band data, the calculated time from step 5.8 is compared with the time ranges specific by the time band data and if it is determined that the calculated time is within the predetermined time ranges, then in the present embodiment at step 5.14 the communications device displays a warning to the user that the call is being made at an inappropriate time for the recipient, and asks for confirmation of the call. If the user confirms that the call should proceed at step 5.16, then the call is continued with at step 5.12. In this respect, the word “call” is also used to represent other communications sessions, for example video sessions, voice over IP sessions, or the like.

If the user declines to continue with the call after being asked for confirmation at step 5.14, as shown at step 5.18, then the call is abandoned at step 5.20. In this case, the communications device simply does not continue with the call at all, and no signalling messages are sent to the network.

Of course, if, at step 5.10, it is determined that the calculated time is not within one of the predetermined time bands within which calls should not be made, then the call is continued with at step 5.12, and set up in the usual way.

In an alternative variant of the first embodiment, steps 5.14 to 5.18 are not included, and instead if the calculated time is determined to be within the predetermined time zone at step 5.10, processing proceeds immediately to step 5.20, wherein the call is abandoned. In this embodiment, the user is not given a chance to confirm whether to continue with the call, and instead the call is simply prevented automatically.

In either variant of the first embodiment, the problems noted previously are overcome in that by estimating the time at the call recipient's location based on the stored time difference, and comparing it with the predetermined time bands, an indication is obtained in advance of the call being set up that the call will be unwanted. Thus, network resources in setting up the call are saved, as well as, where charges are applied for call set ups, unnecessary costs.

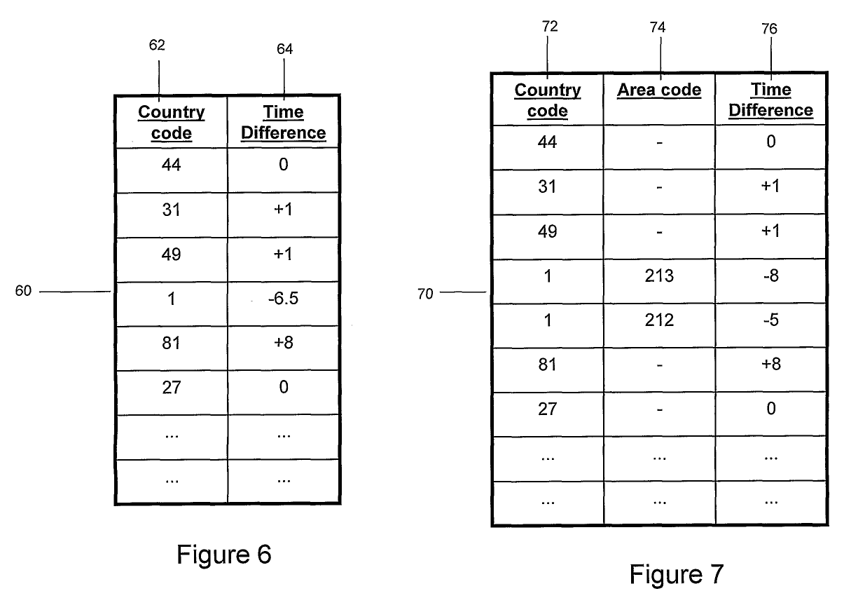

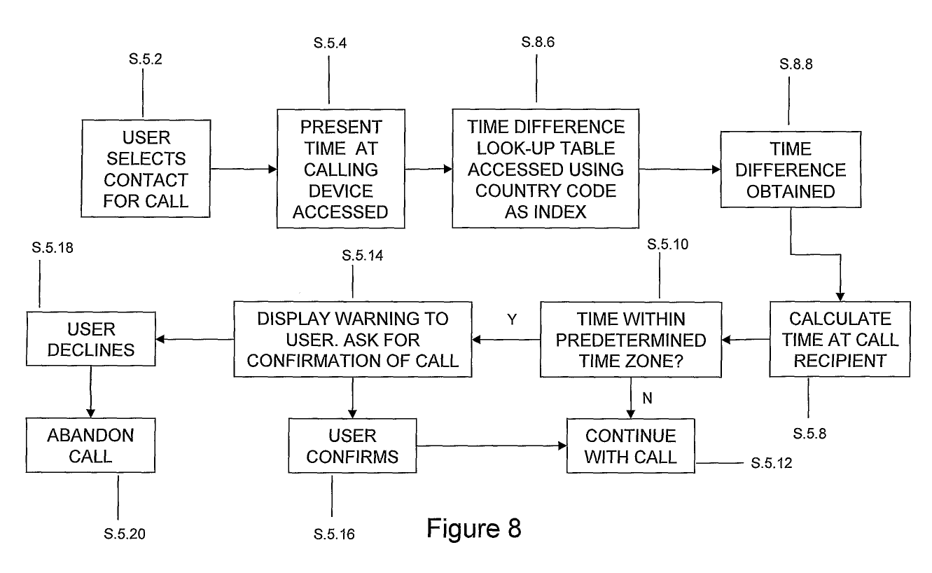

A second embodiment of the invention will now be described with respect to FIGS. 6 and 8. As with the first embodiment, the second embodiment may be implemented in any of a mobile communications device 10, or a fixed line communications device, such as telephone 20. It can also be used with computer based voice over IP implementations, such as represented by computer 30.

Within the second embodiment, the communications device implemented in the embodiment, in addition to storing contact data in the conventional manner, also stores a time difference look up table 60, which contains a column of time difference data 64, indexed by telephone dialling number country code, as shown in column 62. As in the first embodiment, the time difference may be represented as being with respect to GMT, or, alternatively, may be with respect to local time of the communications device, where the communications device is not located in GMT. In the example shown in FIG. 6, the time difference is shown with respect to GMT, and hence 0 is given as the time difference for the country code “44”, which represents the United Kingdom. As a further example, +8 is given as the time difference for the country code “81” which represents Japan.

For some countries, however, the countries are so large that they extend over several time zones. An example is the United States, represented by country code “1”. For the United States in particular, the time difference extends from −5 hours GMT on the East coast of the country, to −8 hours GMT on the West coast of the country, excluding any adjustments made for daylight saving time. However, in the present embodiment which operates based on country code alone, only one time difference value can be entered against the country code for the country concerned. In this case, an average time difference value is obtained from the different time differences across the country. Therefore, in the case of the United States represented by country code “1”, a time difference value of −6.5 is shown in the time difference column 64.

FIG. 8 illustrates a flow diagram of the operation of the communications device in accordance with the second embodiment. In this respect, steps 5.2, 5.4, and 5.8 to 5.20 are the same as described previously in the first embodiment, with respect to FIG. 5. No repeat explanation will therefore be made of these steps. The differences lie in steps 8.6 and 8.8, wherein the appropriate time difference to be applied is obtained.

More particularly, in a communications device operating in accordance with a second embodiment, in addition to storing the conventional contacts data, the time difference look up table 60 is also stored. When a contact has been selected for a call, at step 5.2 the number is accessed by the device in preparation for setting up the call. The country code at the start of the number is then used at step 8.6 as an index into the time difference look up table 60, indexing into the country codes given in column 62 thereof. The associated time difference value to the country code obtained from the number to be called is then obtained from column 64 of the time difference look up table 60, and this can be used at step 5.8 to calculate the time at the intended call recipient, in the manner previously described in respect of the first embodiment. Thereafter, processing proceeds in an identical manner as to the first embodiment, wherein the estimated time is compared with the predetermined time bands, and the operation of the communications device is altered in dependence thereon, again in the same manner as previously described in the first embodiment.

With the second embodiment, therefore, it is not necessary for the contact data to contain time difference values therein, or for the user to calculate and enter such time difference values, when he is entering the contact data. Instead, the communications device operating in accordance with the second embodiment can be supplied pre-stored with the time difference look up table 60 indexed by telephone dialling country codes, and then operate in accordance with the method shown in FIG. 8 so as to prevent calls being made at inappropriate times.

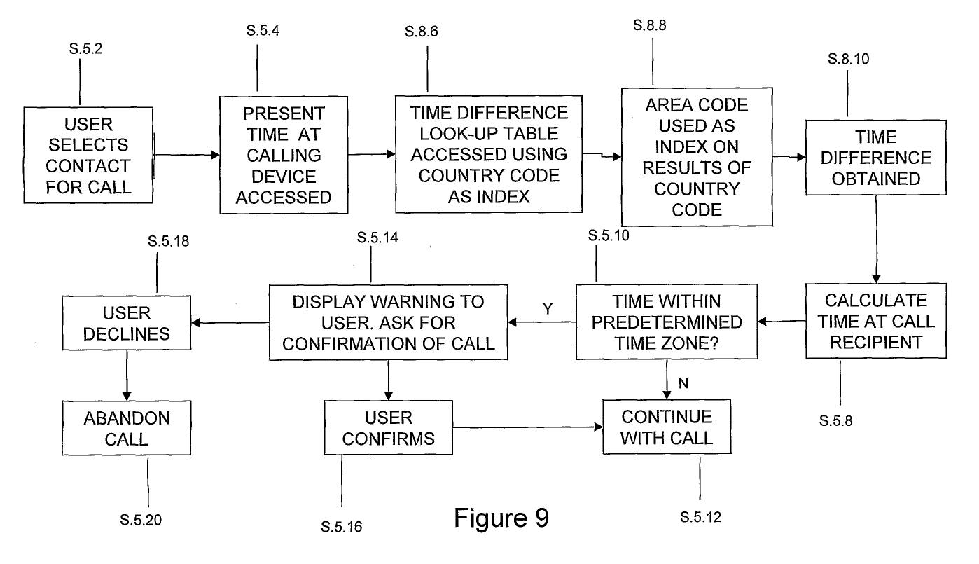

A third embodiment will be described with respect to FIGS. 7 and 9. The third embodiment is closely related to the second embodiment, but further addresses the problem of dealing with countries which are so large that they extend over more than one time zone.

More particularly, it was noted in the discussion of the second embodiment that some countries are so large that they extend across more than one time zone, such as the United States. Other countries which have this problem are, for example, Canada, Russia, China, and Australia. In order to account for countries such as these, in the third embodiment the time difference look up table is supplemented, to give the time difference look up table 70 as shown in FIG. 7. Here, it will be seen that an extra column has been added in the form of area code column 74. Thus, time difference look up table 70 comprises a country column 72 comprising telephone dialling number country codes, and area code column 74, containing area codes for those countries which extend over more than one time zone and a time difference column, containing time difference values in hours for each country code and area code combination. Where no area code is included corresponding to a country code, then this is because the country extends only within one time zone and hence area codes are not necessary. This allows the look up table 70 to be kept as small as possible, thus saving memory.

A communications device operating in accordance with the third embodiment operates as shown in FIG. 9. Here, steps 5.2, 5.4, and 5.8 to 5.20 are the same as previously described with respect to the first and second embodiments, and further description thereof will not be undertaken. The difference lies in steps 8.6 to 8.10, which make use of the time difference look up table 70.

Here, at step 8.6 the communications device accesses the country code column of the time difference look up table, using the country code obtained from the number to be called as an index thereto. Next, at step 8.8, the communications device looks at the area code column. If the area code column for the appropriate country code contains a null value, then this is because the country does not extend over more than one time zone, and hence the corresponding time difference value for the country code can be read from column 76. Otherwise, where there are area code values in the area code column for the particular entries corresponding to the country code, the area code from the telephone number to be called is used as an index into the area code column, to determine the particular entry to be used. In this manner, the appropriate time difference for the country code and area code of number to be dialled can be obtained, at step 8.10. This time difference is then used at step 5.8 to calculate the estimated time at the call recipient location, in the manner described previously. The behaviour of the communications device can then further be altered in the manners described previously with respect to the first and second embodiment.

Thus, the third embodiment improves upon the second embodiment by allowing for numbers located in countries which extend over more than one time zone to be handled more accurately, and a more accurate time estimate of the time at the location of the number to be called to be obtained. This more accurate estimate is then used to determine whether the call should proceed, in the manner described previously.

With respect to the second and third embodiments, there remains the problems of roaming mobiles. Whilst the time difference look-up operations work well for fixed line telephones, for mobile telephones the time difference look-up may result in an incorrect result. Therefore, for mobile telephone numbers it is still preferable to maintain, in the contacts database, an indication of local time at the device, or time difference. This local time or time difference data can be updated to account for the roaming of a mobile telephone using one of the signalling techniques described previously in respect of the first embodiment.

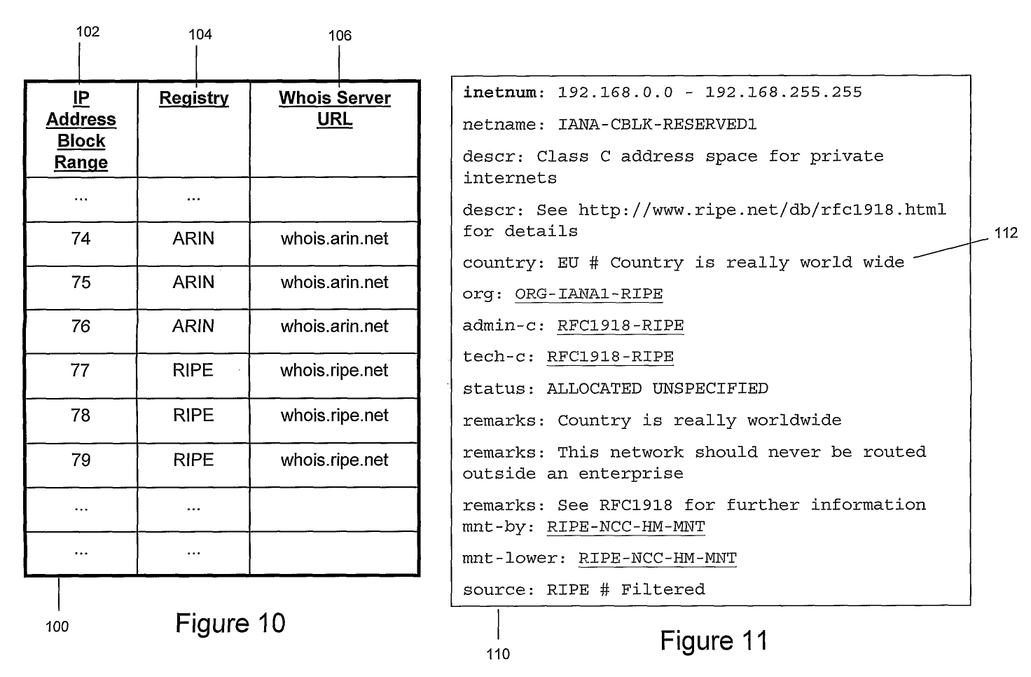

A fourth embodiment of the invention will now be described with respect to FIGS. 10 to 13, which embodiment is particularly directed to communications devices which use the voice over IP protocols for communications, sending voice in Internet Protocol (IP) packets, to a destination IP address. Such communications are typically undertaken by, for example, computers 30, equipped with appropriate voice over IP software. However, it is becoming increasingly common for particularly fixed line telephones such as telephone 20 when connected to an appropriate DSL gateway to also allow for voice over IP connection, using a DSL Internet connection.

Within voice over IP telephony, voice data is packetized into IP packets, and transmitted over an IP network to a destination machine, which has an assigned IP address. At the present time, Internet Protocol version 4 is used in most of the Internet which has IP addresses in the form of four 8 byte octets, which are represented in human readable form as four numbers between the values of 0 and 255, separated by dots i.e.:—

192.168.30.68.

In the future, Internet Protocol version 6 allows for an expanded address space, but at the present time IPv6 is not much used.

Although the address space for IP is large it is also finite, and hence careful management of the address space is required. This is performed at the top level by the Internet Assigned Numbers Authority (IANA) which delegates blocks of addresses to Regional Internet Registries (RIRs) which in turn follow their regional policies for further sub-delegation of IP address resources to their customers, which include Internet service provides, and end user organisations. At present, there are five RIRs in operation as follows:—
American Registry for Internet Numbers (ARIN) for North America.
RIPE Network Co-ordination Centre (RIPENCC) for Europe, the Middle East, and Central Asia.
Asia Pacific Network Information Centre (APNIC) for Asia and the Pacific region.
Latin American and Caribbean Internet Address Registry (LACNIC) for Latin America and the Caribbean region.
African Network Information Centre (AfriNIC) for Africa.

For the IPv4 address space, the entire address space has almost all been allocated, in blocks based on the first octet. The allocation can be found on the IANA website, at the following URL:—

http://www.iana.org/assignments/ipv4-address-space

In particular, the information at the above URL indicates to which RIR an IP address block range has been allocated, or to which organisation.

In terms of using destination IP address as an indication of the geographical location (and hence time zone) of a communications device using that IP address, for some IP addresses, and in particular those allocated to organisations such as large corporations with establishments all over the world, the IP address falling within a range allocated to such an organisation will not give a good indication of a geographical location of the device using that IP address. However, for the vast majority of IP addresses, which have been allocated by LANA to the Regional Internet Registries, there is some correlation between IP address and region, and hence geographical location. Moreover, the Regional Internet Registries each provide a WHOIS server at particular URLs, which can be accessed and provided with an IP address, to obtain further information as to the allocation of that address. FIG. 11 shows the results returned from the WHOIS server from RIPENCC, the RIR for Europe and the Middle East. Here, the WHOIS results 110 contain a country field 112, indicating, that for IP addresses in the range given in the top field of 192.168.0.0 to 192.168.255.255, the predominant region of use of these IP addresses is within the EU, although remarks are included that the country may also be worldwide. Nevertheless, for IP addresses the WHOIS results from the RIR WHOIS servers may provide at least an indication of country or the general location of the device to which the IP address has been allocated. This can be used in the fourth embodiment of the present invention to allow for at least an estimate of the time at the location of an intended recipient of a VoIP call to be obtained, which can then be used to alter the communication device's behaviour, for example to abort the call before it is set up.

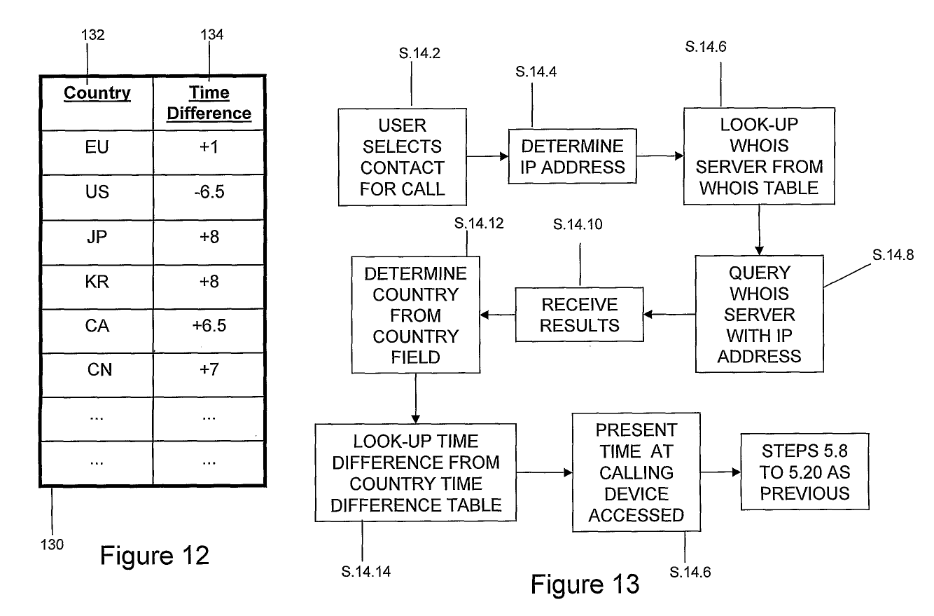

More particularly, a communications device such as the computer 30 operating in accordance with the fourth embodiment of the invention stores look up tables, as shown in FIGS. 10 and 12. More particularly, a first look up table of data 100, is stored, which relates IP address block ranges to the Regional Internet Registries to which those blocks have been allocated, and further stores the URL of the WHOIS servers for the particular Registry. Thus, as shown in FIG. 10, the look up table 100 contains a first column 102 with a row for each possible IP address block value from 0 to 255. A Registry column 104 is further included, containing the ID of the Regional Internet Registry, or other organisation, to which the corresponding IP address block range has been allocated by IANA. Moreover, a further column 106 is also provided containing the URLs of the WHOIS server relating to the address block range. The look up table 100 therefore allows a communications device such as a computer 30 which, having obtained a destination IP address for a VoIP call can then use the first number of the address to determine the WHOIS server to which a WHOIS query should be sent, to try and determine the geographical location of the IP address.

The second table of data which is stored is a time difference data table 130, as shown in FIG. 12. Here, it will be seen that time difference values in hours are stored, indexed by two letter country or region code. Thus, having obtained information from a WHOIS server as to the possible country of an IP address, a communications device implementing the fourth embodiment can then use the time difference look up table 130, to obtain an estimate of the time difference to be applied to obtain an estimate of destination local time. Here, as with the second embodiment described previously, it will be seen that for countries which are so large as to contain more than one time zone, such as the United States, an average time difference is used, although this is not essential.

Having been provided with the data in tables 100 and 130, as described above, a communications device such as computer 30 implementing the fourth embodiment then operates in accordance with the procedure shown in FIG. 13. More particularly, at step 14.2 a user of the communications device selects a contact to which a VoIP call should be made. At step 14.4 a computer 30 running the VoIP software then determines the IP address for the contact. In this respect, where the IP address is stored in the contact data in the computer, then the IP address is read from the contact data. Alternatively, where no IP address is stored, but, for example, a domain is indicated, together with a user name, then a domain name look up can be performed by the device from a domain name server, to obtain the IP address.

Having obtained the IP address, at step 14.6 the communications device such as the computer 30 then accesses its stored WHOIS table 100, and looks up the relevant WHOIS server using the first value of the IP address as an index thereto. At step 14.8 a database query is then sent to the WHOIS server to obtain information relating to the IP address determined at step 14.4. After an unspecified amount of time, the WHOIS server will likely respond with results, typically in the form discussed previously with respect to FIG. 11. If the WHOIS server does not respond after step 14.8, then after an appropriate amount of time to allow the server to respond, the procedure aborts, and the user is informed. In this case, the user may be asked whether he wishes to continue placing the call anyway.

However, if, at step 14.10, results are received from the WHOIS server of the appropriate RIR, or other organisation, then the results are examined, and in particular the country field of the results, as shown in FIG. 11, to determine the country or region to which the IP address is likely allocated. Having obtained a country from the country field of the WHOIS results, at step 14.14 the time difference look up table 130 is accessed, to obtain a time difference value to be applied, using the country information as an index thereto. Having obtained the time difference to be applied, then at step 14.6 the present time at the calling device, such as the computer 30, is accessed, and hence thereafter an estimate of time at the intended call recipient's possible location can be obtained. This estimate can then be used to determine if either the call should be abandoned, or the user asked to confirm whether he wishes to continue with the call, as described in the previous embodiments.

Thus, with the fourth embodiment even when VoIP is used to carry the voice traffic, it is possible to obtain an estimate of the time and destination of the traffic, being the intended recipient's destination, and hence make an evaluation as to whether it is appropriate to continue with the call, bearing in mind the possible local time at the intended recipient's destination. Whilst IP addresses, as discussed, are not as rigorously allocated as telephone numbers, such that it is not in some cases possible to make a definite determination as to country based on IP address, many ranges of IP addresses are assigned to particular regions. Generally, therefore, for many IP addresses it will be possible to tell whether the call is being made at a completely inappropriate time, such as the middle of the night. That is, in view of the fact that many IP addresses are assigned to the RIRs, and that the geographical coverage of each RIR is typically four or five time zones, then it is possible to make an estimate of time accurate to within typically four or five hours. Thus, it will be possible to determine even with this level of time accuracy whether a call is being made at a completely inappropriate time.

However, depending on the IP address, and the regional allocation policies, in many cases it may in fact be possible to determine the geographical location of an IP address much more accurately, thus narrowing down the margin of error on a time estimate thus obtained.

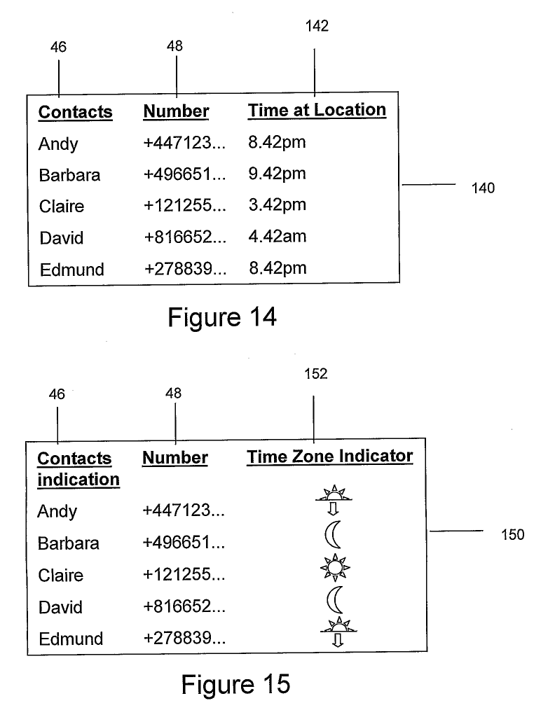

The above described embodiments make use of a comparison of the time estimate for the intended recipient with predetermined time bands within which a call may or may not be made, and then the behaviour of the calling device is altered in dependence with the comparison of the estimated time with the predetermined time zones. However, comparison of the time estimate obtained for the intended recipient with the predetermined time zones is not essential, and neither is the alteration of the operation of the calling device in dependence on the result of such a comparison. In further embodiments, therefore, the estimated time, or an indication thereof, at the intended recipients is displayed to the user, and it is left to the user to decide whether the call should be made. Further embodiments based on this principle will be described with respect to FIGS. 14 to 19.

More particularly, a fifth embodiment of the invention is represented by FIG. 14. Here, a calling device such as mobile telephone 10, or fixed line telephone 20, maintains a contact list of possible intended recipients, comprising contact identification information 46 in the form of names, and contact routing or address information 48, in this case in the form of telephone numbers. Additionally, according to this embodiment, within the contacts list the calling device also maintains additional data in the contacts list being in this case an entry for the time at the contact location, shown in column 142. Thus, as will be seen in FIG. 14, contact data 140 contains, for each contact, an estimate of time at that contact's location. For example, the time at Barbara's location is estimated to be 9.42 pm. Within this embodiment, in contrast with previous embodiments, the contacts data 140 maintains the time at the location for each contact, the time being updated for each contact by reference to the local clock in the calling device. Preferably, the time is initially stored in the contact data by the user, i.e. when the user enters the contact data such as the name and telephone number, then at the same time the user enters the present time at the contact's location when the contact data is entered into the time-at-location field in column 142. Once entered, thereafter the time is automatically updated by the calling device by reference to its own clock. In this way, when the contacts list is accessed later, then the time shown for each contact represents the present time at the contacts location.

For mobile telephones which roam, the time data for each entry can be maintained using, for example, one of the signalling techniques described previously in respect of the first embodiment. Here, a roaming mobile would send a time control message to its contacts when it entered a foreign country, informing of its local time. This time control message is then received at a calling device, parsed, and the time data in the calling device's contact data updated appropriately. Alternatively, as described previously the time control message could be sent from a server which the mobile phone is registered with, operated for example by its home mobile network.

In operation, the fifth embodiment described with respect to FIG. 14 therefore displays to the user of the calling device the time at the location of each contact in the contact list when the contacts list is accessed. Therefore, when the user is selecting a contact from the contact list to dial, the user will see the time at the intended recipient's location, and will be able to make an estimation for himself as to whether the time is inappropriate. This is therefore a much simpler embodiment than the previous embodiments, but is highly effective in addressing the noted problem of unwanted calls at inappropriate times.

A sixth embodiment of the invention will be described with respect to FIG. 15. Here, a calling device such as mobile phone 10 or fixed line telephone 20 maintains contact data 150, comprising contact name information 46, and contact addressing or routing information 48, in this case in the form of name and telephone numbers. Different to the previous embodiment, however, instead of showing a specific time at an intended recipient's location, in column 152 the contacts data includes a time zone indicator, containing a symbol indicating the time at the contact's location. For example, the indicator may indicate whether the time is during the night (shown for example by a crescent moon symbol), during the day (shown for example by a sun symbol), or at, for example, dawn or dusk times, again shown by appropriate symbols (in this case sunrise or sunset symbols).

In terms of how the correct time zone indicator symbols are derived, a series of time bands are defined for each symbol, and when it is determined that the estimated time at the intended recipient's location is within such a time band, the appropriate symbol for that time band is displayed next to the relevant contact. Thus, for example, the “moon” symbol could have an associated time band of 11 pm to 5 am, whereas the “sunset” symbol may have an associated time band of from 6.30 pm to 11 pm. A time zone indicator symbol is allocated to each time band across the entire 24 hour period.

However, it is first necessary to obtain an estimate of the time, in order to determine which of the correct time zone indicator symbols should be displayed. In this respect, the time estimate can be obtained in any of the manners described in the previous embodiments. For example, with reference to the fifth embodiment just described, a user may directly enter the time at a contact location, with the time then being updated by the calling device as appropriate. When the contacts list is then displayed to the user, the time being maintained for each contact is compared with the predetermined time bands to determine which time zone indicator graphic should be displayed.

Alternatively, in other embodiments time difference meta data may be stored with respect to each contact, and then the time difference meta data used in conjunction with the calling device's own clock, to determine an estimate of the time at the contact location, and hence the time zone indicator symbol which should be displayed. In another variant, the techniques described in previous embodiments may be used, wherein a look up table which relates country code (and, optionally, area code) to a time difference, is used, and then subsequently, having determined the time difference from the country code of the telephone number, an estimate of time can be obtained, which is then used to determine the appropriate graphical symbol. Any of these techniques may be used to determine the time at the potential intended recipient's location, and hence the time zone indicator symbol which is displayed in the contacts list 150.

For mobile telephones, the time difference or local time update signalling protocols mentioned previously may be used.

The provision of the sixth embodiment within a calling device such as a mobile telephone 10, or fixed line telephone 20, allows a user to be given an indication of the time at the potential intended recipient's location, and user can then decide for himself whether to proceed with a call to that intended recipient. In this respect, the time zone indicator symbol of the sixth embodiment does not in fact present to the user as much information as the time indication of the fifth embodiment but in many cases this will be sufficient. For example, where the call is intended to be made during work hours an indication that the time is any of sunset, night, or sunrise is sufficient to indicate to the caller that the call is likely to be unwanted.

The fifth and sixth embodiments just described therefore present techniques for indicating the time at a potential recipient's location, within the contacts list maintained at a calling device such as a mobile telephone 10 or fixed line telephone 20. However, in some cases a contacts list is not accessed before a call is made, for example where a user knows the telephone number off by heart, or where the number is set up as a speed dial. With a typical speed dial arrangement, telephone numbers can be allocated to speed dial buttons such that when a button is pressed, the number associated with that button is entered into the telephone automatically, and dialled. The seventh and eighth embodiments to be described next therefore address the issue where a user has entered a telephone number manually, or pressed a speed dial button to access a stored telephone number.

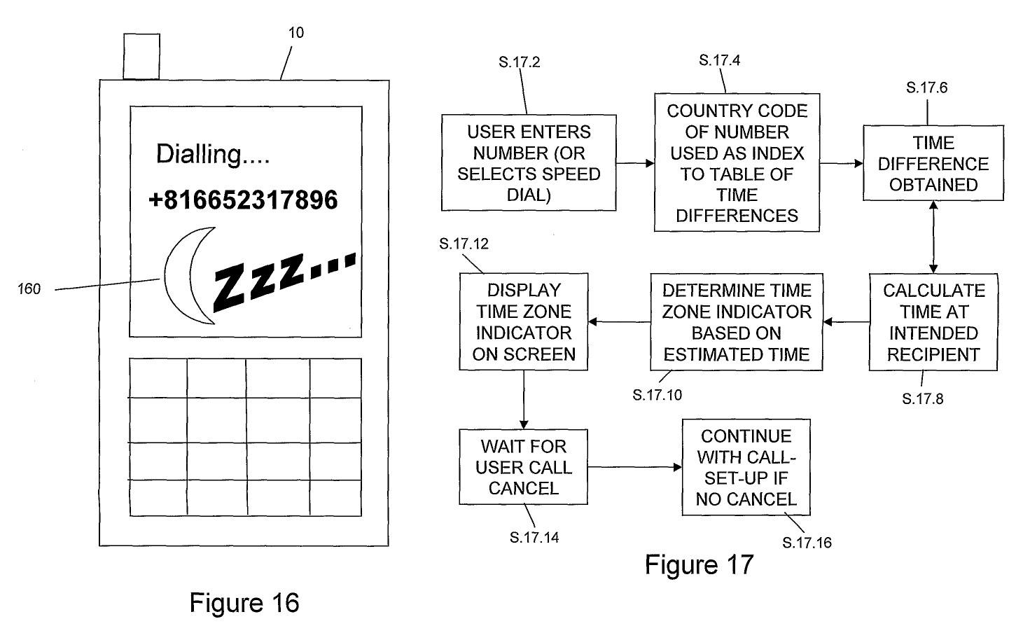

More particularly, a seventh embodiment is shown in FIGS. 16 and 17. Here, a calling device such as mobile telephone 10 having a keypad (as described previously) has a telephone number entered thereon by the user for dialling, or the user selects a speed dial number. This occurs at step 17.2 of the process running on the calling device 10 to determine time zone indicators.

Once the user has entered a number, or selected a speed dial, before the calling device 10 initiates the call, it first, at step 17.4, uses the country code (and, optionally, area code) of the entered number as an index to a table of time differences. In this respect, as described in respect of the second and third embodiments, the calling device 10 can store a look up table 60 or 70 (as described previously, and shown in FIGS. 6 and 7) which indexes country code and, optionally, area code, to a time difference. The time difference can thus be obtained from such a look up table at step 17.6, and then, with reference to the internal clock of the calling device 10, the time at the intended recipient can be calculated at step 17.8. At step 17.10 in the seventh embodiment, a time zone indicator based on the time estimate obtained at step 17.8 is determined, and at 17.12 the determined time zone indicator is then displayed on the screen. This is shown as time zone indicator 160 in FIG. 16. As in the previously described embodiment, several time zone indicators can be defined to specify different times of day or night, and a time band is associated with each time zone indicator, such that if the estimated time at the intended recipient's location is within a time band, then the associated time zone indicator symbol is displayed.

Having displayed the time zone indicator to the user on the screen, the calling device 10 then preferably waits a certain amount of time to give the user opportunity to see the time zone indicator symbol, and to decide whether the call should be continued. For example, the calling device 10 may wait 5 seconds, or a similar period of time, for the user to cancel the call. The user may cancel the call by pressing the call cancel button that is typically standard on most calling devices, such as mobile phone 10. However, if, after waiting for the user to cancel the call at step 17.14, no cancel command has been received, then at step 17.16 the calling device continues with the call set up, and makes the call in the conventional manner.

Thus, with the seventh embodiment an indicator of time zone at an intended recipient's location can be given to a user after the user has entered a number to be dialled, and hence the user is given an opportunity to cancel the call before the call is made.

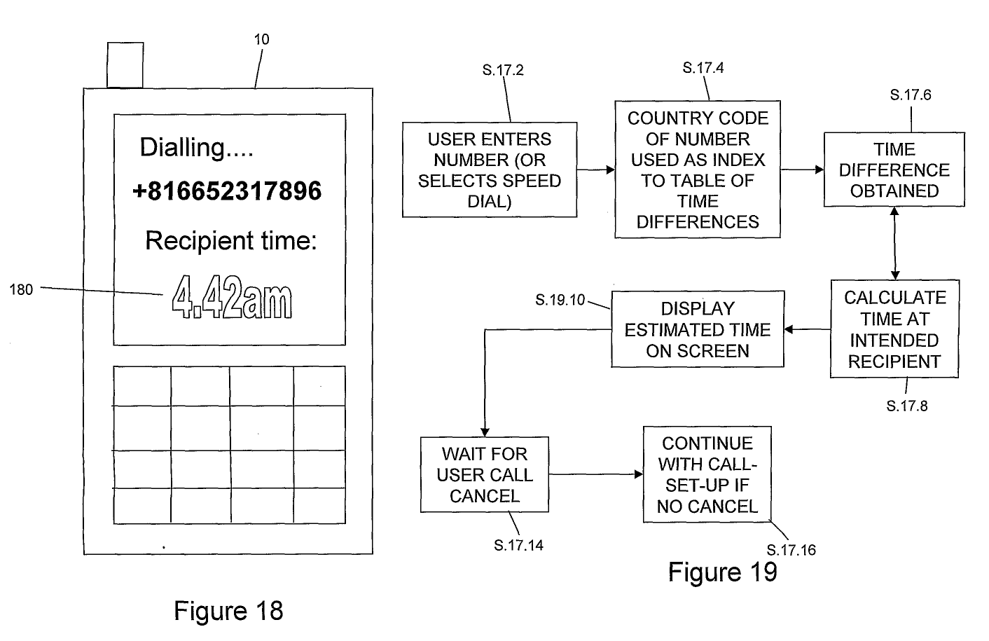

FIGS. 18 and 19 show a further, eighth, embodiment, which is very similar to the seventh embodiment just described. However, instead of determining a time zone indicator based on the estimated time and displaying the time zone indicator on the screen, in the eighth embodiment once the time has been estimated at the intended recipient's location then the estimated time is directly displayed on the screen at step 19.10. This can be seen in FIG. 18, where time 180 is shown. As in the seventh embodiment, the calling device 10 waits a certain amount of time for the user to cancel the call after the estimated time has been displayed on the screen, but continues with the call set up if the user does not cancel call.

Within the seventh and eighth embodiments, where the number is a mobile number, then preferably an indication of local time or time difference to local time is stored in the contacts data together with the mobile number. This data is then used to determine the correct symbol, or is displayed on the screen. Moreover, the data can be update using one of the signalling protocols described previously.

Therefore, with the fifth to eighth embodiments just described, therefore, the burden is shifted to the user to decide whether to proceed with the call. However, to aid the user an indication of the time zone of the intended recipient, either in the form of a graphical symbol indicating time of day or, the actual estimated time itself, is provided to the user on which the user can base his decision.

Within each of the embodiments described above the communications device according to an embodiment contains a control unit, which may be embodied in hardware or software, which causes the communications unit to operate as described. For example, the control unit may be a microprocessor provided with appropriate control software and arranged to control the communications device. In other embodiments the control unit may be an application specific IC (ASIC) especially provided to control the communications device accordingly. In further embodiments various programmable logic chips may be used to provide the control unit, being suitably programmed to operate as described. For example, an FPGA may be used.

A ninth and final embodiment will now be briefly described.

Within the previously described embodiments, we focussed on actions being performed at a calling device to make a caller aware of the time at a recipient location. However, this is not essential, and actions can be performed at other elements in the signalling chain, for example in a connecting network, and in particular in the home network of the called device

For example, where the called device is a fixed line telephone, the last hop switch in the PSTN to which the fixed line telephone is connected may, before, finalling connecting the call, make a determination as to local time, and if the local time is within a predetermined time band, signal backwards that a warning message should be passed to the caller before the connection is finally established. Alternatively, instead of signalling backwards, the last hop switch may re-route the call to a message generator located locally thereto, which then generates a warning message. For example, after the warning message, the user could be asked to indicate whether he/she wishes to continue with the call, for example by pressing a signalling button, such as the hash key. The resulting DTMF tone generated is then detected by the last hop switch, and the call finally connected if the signal indicates that the call should proceed.

A similar arrangement could be put in place where the called device is a mobile telephone. For example, with a GSM mobile phone a network element such as the Home Location Register (HLR) of the phone's home mobile network will know the identity of the Visitor Location Register (VLR) of the network with which a roaming mobile is registered. With the identity known, it becomes possible to have a look-up table of VLRs and times or time differences, and to identify that the mobile phone is roaming in a different time zone. The HLR may then cause a call set up request to be turned down, or a warning message to be played back to the caller, if it is determined that the local time of the mobile is in a particular time zone, such as the middle of the night.

The described embodiments of the invention therefore present several techniques for allowing an estimate of time at the location of an intended call recipient to be made in advance of the call being set up, and which can then optionally be used to alter the behaviour of a communications device in dependence thereon, or alternatively provide information to the user on which the user can base his own decision as to whether the calling device behaviour should be modified, for example by the call being cancelled. Where the onus is on the calling device to police the call, the calling device behaviour may be altered so as to ask the user to confirm whether he wishes to continue with the call, or to simply abandon the call or communications session altogether. In either case, the problem of unwanted calls at inappropriate times can be alleviated from the caller end, without incurring unnecessary call set-up processes, and the associated wasted costs.

Various modifications may be made to the above described embodiments which are apparent to the person skilled in the art, to provide further embodiments, any and all of which are intended to be encompassed by the appended claims.

1-44. (canceled)

45. A method of operating a communications device comprising, prior to initiating a communications session with an intended recipient, determining an estimate of local time at the perceived location of the intended recipient; and controlling the communications device to perform an operation in dependence on the determined estimate, wherein controlling the communications device comprises displaying at least an indication of said determined time estimate to a user of the communications device, and said indication is displayed in a contacts list of possible intended recipients.

46. A method according to claim 45, wherein the indication is a graphical symbol indicative of a time range within which the determined estimate falls.

47. A method according to claim 45, wherein the indication is the determined time estimate.

48. A method according to claim 45, wherein controlling the communications device comprises:—
i) comparing the estimate of local time with a set of one or more time ranges to see if said estimate of local time falls substantially within or without said range(s); and
ii) altering the operation of said communications device in initiating said communications session in dependence on said comparison.

49. A method according to claim 48, wherein altering the operation of said communications device includes alerting a user to the results of said comparison, and prompting said user to indicate if the initiation of said communications session should proceed.

50. A method according to claim 45, wherein the determination of local time at the intended recipient comprises maintaining time data for possible intended recipients.

51. A method according to claim 45, wherein the determination of local time at the intended recipient comprises:—
i) storing time difference data for the intended recipient;
ii) obtaining local time to the communications device; and
iii) calculating the estimate of local recipient time by applying said time difference data to the obtained local time.

52. A method according to claim 45, wherein the determination of local time at the intended recipient comprises:—
i) storing time data indexed by recipient communications session address; and
ii) applying the communications session address of the intended recipient to the stored time data to determine relevant time data.

53. A method according to claim 45 wherein the determination of local time at the intended recipient comprises:—
i) querying an external database using the intended recipient's communications session address;
ii) obtaining, in response to said query, an indication of the intended recipient's geographical location;
iii) storing time data indexed by geographical location, and looking up time data to be used in said determination based on the indication of the intended recipient's geographical location received from the database;
iv) obtaining local time to the communications device; and
v) calculating the estimate of local recipient time by applying said time data to the obtained local time.

54. A communications device comprising a communications session control unit arranged to, prior to initiating a communications session with an intended recipient, determine an estimate of local time at the perceived location of the intended recipient; and control the communications device to perform an operation in dependence on the determined estimate, wherein said controlling unit is further arranged to display at least an indication of said determined time estimate to a user of the communications device on a display screen of the device, and said indication is displayed in a contacts list of possible intended recipients.

55. A device according to claim 54, wherein the indication is a graphical symbol indicative of a time range within which the determined estimate falls.

56. A device according to claim 54, wherein the indication is the determined time estimate.

57. A device according to claim 54, wherein the control unit is further arranged to:—
i) compare the estimate of local time with a set of one or more time ranges to see if said estimate of local time falls substantially within or without said range(s); and
ii) alter the operation of said communications device in initiating said communications session in dependence on said comparison.

58. A device according to claim 54, wherein said control unit is further arranged to alert a user to the results of said comparison, and prompt said user to indicate if the initiation of said communications session should proceed.

59. A device according to claim 54, wherein the determination of local time at the intended recipient comprises maintaining time data for possible intended recipients.

60. A device according to claim 54, wherein the control unit determines local time at the intended recipient by:—
i) storing time difference data for the intended recipient;
ii) obtaining local time to the communications device; and
iii) calculating the estimate of local recipient time by applying said time difference data to the obtained local time.

61. A device according to claim 54, wherein the control unit determines local time at the intended recipient by:—
i) storing time data indexed by recipient communications session address; and
ii) applying the communications session address of the intended recipient to the stored time data to determine relevant time data.

62. A device according to claim 54 wherein the control unit determines local time at the intended recipient by:—
i) querying an external database using the intended recipient's communications session address;
ii) obtaining, in response to said query, an indication of the intended recipient's geographical location;
iii) storing time data indexed by geographical location, and looking up time data to be used in said determination based on the indication of the intended recipient's geographical location received from the database;
iv) obtaining local time to the communications device; and
v) calculating the estimate of local recipient time by applying said time data to the obtained local time.

63. A program or suite of programs for controlling the operating of a communications device, the program being arranged when executed to control the communications device so as to, prior to initiating a communications session with an intended recipient, determine an estimate of local time at the perceived location of the intended recipient; and control the communications device to perform an operation in dependence on the determined estimate, wherein controlling the communications device comprises displaying at least an indication of said determined time estimate to a user of the communications device, and said indication is displayed in a contacts list of possible intended recipients.

64. A storage medium storing a program or at least one of the suite of programs according to claim 63.
